(19) United States
(12) Patent Application Publication
(10) Pub. No.: US 2011/0159710 A1
(43) Pub. Date: Jun. 30, 2011

(54) ARRAY OF ELECTRICAL CONNECTORS HAVING OFFSET ELECTRICAL CONNECTORS

(76) Inventors: Alan D. Crighton, Apex, NC (US); Steven E. Minich, York, PA (US)

(21) Appl. No.: 12/949,241

(22) Filed: Nov. 18, 2010

Related U.S. Application Data
(60) Provisional application No. 61/291,569, filed on Dec. 31, 2009.

(51) Int. Cl. H01R 12/70; H01R 24/00; H01R 43/00

(52) U.S. Cl. 439/65; 439/660; 29/825

(57) ABSTRACT

An array of electrical connectors is provided having a first plurality of electrical connectors configured to be mounted on a substrate, and a second plurality of electrical connectors configured to be mounted on the substrate at a location adjacent the first plurality of electrical connectors, such that the first plurality of electrical connectors is offset with respect to the second plurality of electrical connectors along an insertion direction.

### CROSS-REFERENCE TO RELATED APPLICATIONS

This patent application claims priority to U.S. provisional patent application No. 61/291,569, filed Dec. 31, 2009, the disclosure of which is hereby incorporated by reference as if set forth in its entirety herein.

### BACKGROUND

Electrical connectors conventionally include a housing that retains a plurality of electrical contacts that define mating ends and opposed mounting ends. The mounting ends of the electrical contacts can be configured to be press fit, surface mounted, or otherwise electrically connected to an electrical component, such as an underlying substrate printed circuit board (PCB). The mating ends can be configured to mate with complementary mating ends of the electrical contacts of a complementary electrical connector so as to establish an electrical connection between the electrical connectors. In some configurations, an array of electrical connectors can be mounted onto a substrate so as to mate with an array of complementary electrical connectors. However, because an insertion force is associated with the mating of a given pair of complementary electrical contacts, and because complementary arrays of electrical contacts include a large number of electrical contacts that are mated, such configurations can be associated with high insertion forces, performed when mating electrical contacts and measured in accordance with Electronic Industries Alliance (EIA) Standard 364-13, which is hereby incorporated by reference in its entirety. The high insertion forces can place high stresses on the electrical contacts.

### SUMMARY

In accordance with one embodiment, an array of electrical connectors includes a first plurality of electrical connectors and a second plurality of electrical connectors. Each electrical connector of the first plurality of electrical connectors includes a connector housing and a plurality of electrical contacts supported by the connector housing. Each electrical contact defines a mounting end configured to electrically connect to a substrate and a mating end configured to electrically connect to a respective electrical contact of a complementary electrical connector of a second array of electrical connectors along an insertion direction. Each electrical connector of the second plurality of electrical connectors includes a connector housing and a plurality of electrical contacts supported by the connector housing. Each electrical contact of the second plurality of electrical contacts defines a mounting end configured to electrically connect to the substrate and a mating end configured to electrically connect to a respective electrical contact of a complementary electrical connector of the second array of electrical connectors along the insertion direction. The mating ends of the electrical contacts of the first plurality of electrical connectors are offset with respect to the mating ends of the electrical contacts of the second plurality of electrical connectors along the insertion direction. At least one of the electrical connectors of the first plurality of electrical connectors has a different number of electrical contacts with respect to at least one of the electrical connectors of the second plurality of electrical connectors.

### DESCRIPTION OF THE DRAWINGS

The foregoing summary, as well as the following detailed description of the preferred embodiments of the application, will be better understood when read in conjunction with the appended drawings. For the purposes of illustrating an array of electrical connectors having offset electrical connectors as described herein, there are shown in the drawings preferred embodiments. It should be understood, however, that the instant application is not limited to the precise arrangements and/or instrumentalities illustrated in the drawings, in which:

FIG. 1 is a perspective view of an electrical connector assembly including a first array of electrical connectors and a second array of electrical connectors each mounted to a respective first and second substrates, showing the electrical connectors of the first array of electrical connectors configured to be mated to the electrical connectors of the second array of electrical connectors;

FIG. 2A is an enlarged perspective view of a portion of the electrical connector assembly illustrated in FIG. 1, showing a first electrical connector of the first array of electrical connectors mounted to the first substrate and a second electrical connector of the second array of electrical connectors mounted to the second substrate;

FIG. 2B is a perspective view of the first and second electrical connectors illustrated in FIG. 2A;

FIG. 3A is a side elevation view of a first leadframe assembly of the second electrical connector illustrated in FIG. 2A;

FIG. 3B is a side elevation view of a second leadframe assembly of the second electrical connector illustrated in FIG. 2A;

FIG. 4 is a perspective view of the first array of electrical connectors schematically illustrated and shown mounted to the first substrate as illustrated in FIG. 1;

FIG. 5A is a perspective view of the second substrate illustrated in FIG. 1;

FIG. 5B is a perspective view of the second array of electrical connectors schematically illustrated and shown mounted to the second substrate as illustrated in FIG. 1;

FIG. 5C is a top plan view of the second array of electrical connectors illustrated in FIG. 5B, showing a first plurality of electrical connectors of the second array offset with respect to a second plurality of electrical connectors of the second array;

FIG. 6A is a perspective view of the second substrate similar to FIG. 5A, but constructed in accordance with an alternative embodiment;

FIG. 6B is a top plan view of the second array of electrical connectors mounted onto the second substrate illustrated in FIG. 6A;

FIG. 7A is a perspective view of the second substrate similar to FIG. 5A, but constructed in accordance with another alternative embodiment; and

FIG. 7B is a top plan view of the second array of electrical connectors mounted onto the second substrate illustrated in FIG. 7A.

### DETAILED DESCRIPTION

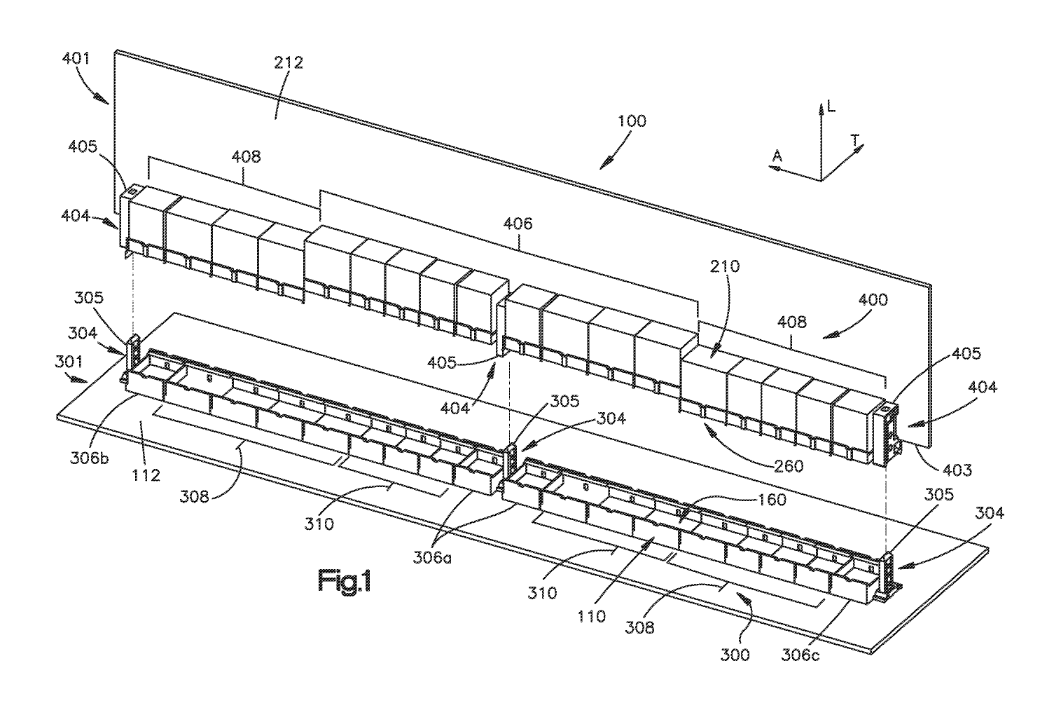

In accordance with one embodiment, insertion force created when two or more right-angle daughtercard connectors mate with corresponding backplane or midplane connectors can be reduced by setting at least one of the two or more right-angle electrical connectors on the daughtercard back from an edge of the daughtercard to stagger the mating of at least two of the two or more right-angle daughtercard connectors. Referring initially to FIG. 1, an electrical connector assembly 100 includes a first array 300 of electrical connectors that includes at least one first electrical connector 110, such as a first plurality of electrical connectors 110. The electrical connector assembly 100 further includes a second array 300 of electrical connectors that includes at least one second electrical connector 210, such as a second plurality of electrical connectors 220. Each of the first electrical connectors 110 is configured to be mounted to a first common substrate 112, and each of the second electrical connectors 210 is configured to be mounted to a second common substrate 212. It should be appreciated, however, that the first electrical connectors 110 can alternatively be mounted to different substrates if desired, such that the first electrical connectors 110 can be mounted to at least the first common substrate 112, and the second electrical connectors 210 can be mounted to at least the second common substrate 212. The first and second substrates 112 and 212 can be configured as printed circuit boards in accordance with the illustrated embodiments. The first and second electrical connectors 110 and 210 are configured to be mated so as to establish an electrical connection between the first and second substrates 112 and 212. In accordance with the illustrated embodiment, the second array 400 of second electrical connectors 210 includes a first plurality 210a of the electrical connectors 210 that is rearwardly offset with respect to a second plurality 210b of the electrical connectors 210.

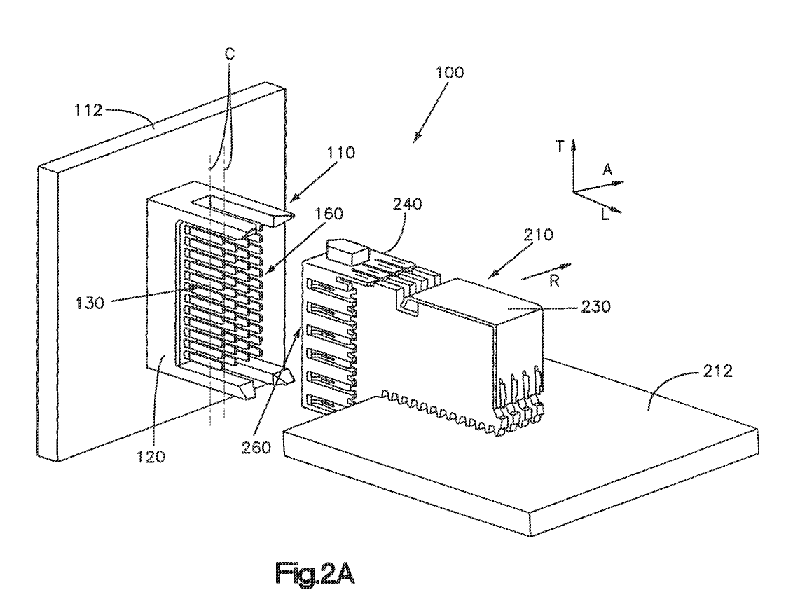

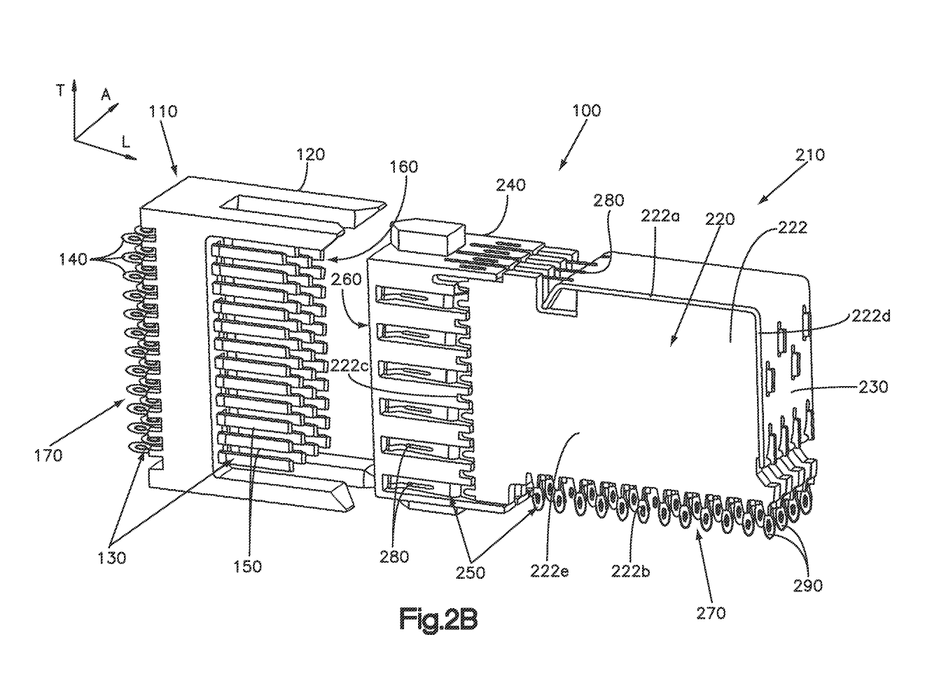

Referring also to FIGS. 2A-B, first and second electrical connectors 110 and 210 can be constructed in accordance with any embodiment as desired, for instance as described in U.S. Pat. No. 7,762,843, issued Jul. 27, 2010, U.S. patent application Ser. No. 12/197,434, filed Aug. 25, 2008, and U.S. patent application Ser. No. 12/140,810 filed Jun. 17, 2008, the disclosure of each of which is hereby incorporated by reference as if set forth in its entirety herein.

In accordance with the illustrated embodiment, the first electrical connector 110 can include a dielectric or electrically insulative first connector housing 120 that carries a first plurality of electrical contacts 130, which can include signal contacts and ground contacts. The first electrical connector defines a mating interface 160 that is configured to mate with the second electrical connector 210, and a mounting interface 170 that is configured to be mounted to the underlying first substrate 112. In accordance with the illustrated embodiment, the mating interface 160 is opposed to the mounting interface 170 along a longitudinal direction L. Likewise, each of the electrical contacts 130 defines a mating end 150 disposed proximate to the mating interface 160 and a longitudinally opposed mounting end 140 disposed proximate to the mounting interface 170. The mating ends 150 are configured to electrically connect to complementary mating ends # of the electrical contacts # of the second electrical connector 210 when the electrical connectors 110 and 210 are mated. The mounting ends 140 can be configured as press-fit tails, surface mount tails, fusible elements such as solder balls, or otherwise configured so as to electrically connect to electrical traces of the underlying substrate 112. Any suitable dielectric material, such as air or plastic, may be used to isolate the electrical contacts 130 from one another. The electrical contacts 130 can be overmolded by the connector housing 120 or stitched into the connector housing 120 as desired. In accordance with the illustrated embodiment, the electrical contacts 130 extend along columns C that are spaced along a lateral direction A that is substantially perpendicular with respect to the longitudinal direction L. The electrical contacts 130 of a given column are spaced along a transverse direction T that is substantially perpendicular to the longitudinal and lateral directions L and A, respectively.

In accordance with the illustrated embodiment, the transverse direction T is oriented vertically, and the longitudinal and lateral directions L and A are oriented horizontally, though it should be appreciated that the orientation of the electrical connector assembly 100 can vary during use. The electrical connectors 110 and 210 are configured to be mated along a longitudinally forward insertion direction, and unmated along an opposed longitudinally rearward direction.

For the purposes of clarity, the same or equivalent elements in the various embodiments illustrated in the drawings have been identified with the same reference numerals. Certain terminology is used in the following description for convenience only and is not limiting. The words “right” and “left”, “upper” and “lower”, and “front and rear” designate directions in the drawings to which reference is made. The words “inward”, “inwardly”, “outward”, “outwardly,” “upward,” “upwardly,” “downward,” and “downwardly” refer to directions toward and away from, respectively, the geometric center of the device and designated parts thereof. The terminology intended to be non-limiting includes the above-listed words, derivatives thereof and words of similar import.

In accordance with the illustrated embodiment, the mating interface 160 of the first electrical connector 110 is disposed proximate to the longitudinal front end of the connector housing 120, and the mounting interface 170 of the first electrical connector 110 is disposed proximate to the longitudinal rear end of the connector housing 120. Thus, the mating end 160 is oriented substantially parallel with respect to the mounting interface 170, and the mating ends 150 of the electrical contacts 130 likewise extend substantially parallel with respect to the mounting ends 140. Accordingly, the first electrical connector 110 can be referred to as a vertical electrical connector, and the electrical contacts 130 can be referred to as vertical electrical contacts. It should be appreciated that the first electrical connector 110 can alternatively be configured as a right-angle electrical connector, whereby the mating interface 160 extends substantially perpendicular to the mounting interface 170, and the electrical contacts 130 can likewise be configured as right-angle electrical contacts whereby the mating ends 150 extend substantially perpendicular with respect to the mounting ends 140. Furthermore, the electrical contacts 130 are configured as header contacts that are configured to plug into, or be received by, respective receptacle contacts of the second electrical connector 210. The first electrical connector 110 can thus be referred to as a header connector. Alternatively, the first electrical connector 110 can be configured as a receptacle connector whose electrical contacts 130 are configured to receive the complementary electrical contacts of the second electrical connector 210.

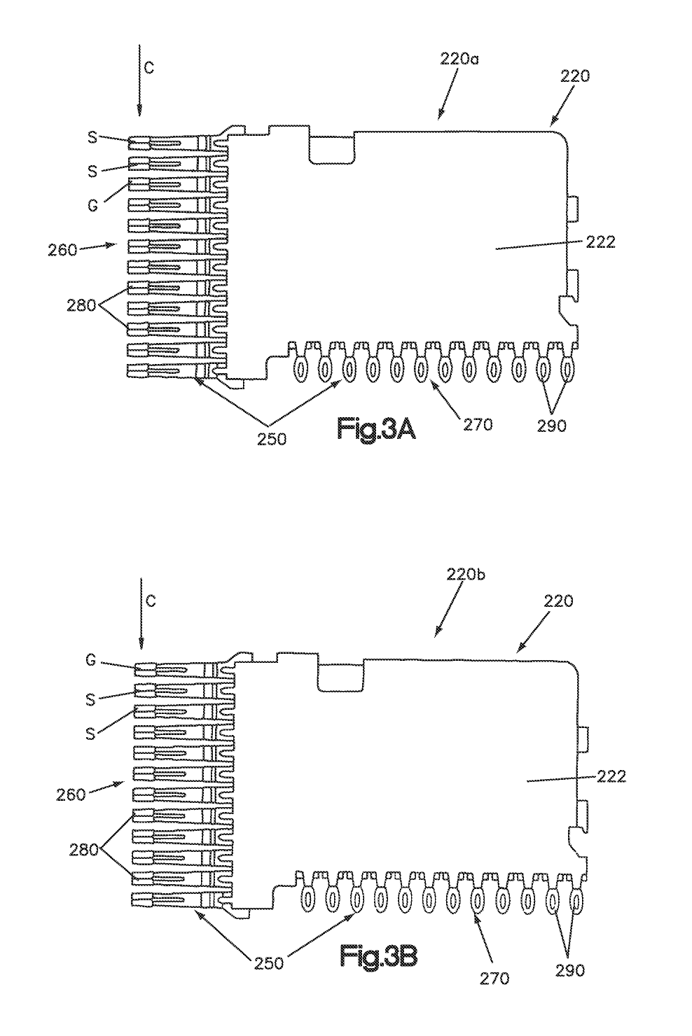

Referring now to FIGS. 2A-3B, each second electrical connector 210 includes a dielectric or electrically insulative second connector housing 240 and a second plurality of electrical contacts 250 that are carried by the connector housing 240. In accordance with the illustrated embodiment, the second electrical connector 210 includes a plurality of leadframe assemblies 220, each including a leadframe housing 222 that carries a plurality of the electrical contacts 250. Each leadframe housing 222 can be a dielectric or electrically insulative. In accordance with one embodiment, the leadframe assemblies 220 can be configured as insert molded leadframe assemblies (IMLAs), whereby the leadframe housing 222 is overmolded onto the electrical contacts 250. Alternatively, the electrical contacts 250 can be stitched or otherwise fixed in the leadframe housing 222.

Each leadframe housing 222 defines a transverse top end 222a and an opposed bottom end 222b, a longitudinal front end 222c and an opposed rear end 222d, and laterally opposed 222e. The second electrical connector 210 defines a mating interface 260 disposed proximate to the longitudinal front end of the connector housing 240 that is configured to mate with the mating interface 160 of the first electrical connector 110, and a mounting interface 270 disposed proximate to the transverse bottom end 222e of the leadframe housing 222 that is configured to be mounted onto the underlying substrate 212. The electrical contacts 250 define respective mating ends 280 that extend longitudinally forward from the longitudinal front end 222c of the corresponding leadframe housing 222 at a location proximate to the mating interface 260. The mating ends 280 are configured to mate, or electrically connect, with the respecting mating ends 150 of the complementary electrical contacts 130 of the first electrical connector 110. The electrical contacts 250 further define respective mounting ends 290 that extend down from the bottom end 222 of the corresponding leadframe housing 222 at a location proximate to the mounting interface 270. The mounting ends 290 are configured to electrically connect electrical traces of the underlying second substrate 212. Any suitable dielectric material, such as air or plastic, may be used to isolate the right angle electrical contacts 250 from one another. The mounting ends 290 can include press-fit tails, surface mount tails, or fusible elements such as solder balls.

The leadframe assemblies 220 can be spaced apart from each other along a lateral row direction R, and the electrical contacts 250 of each leadframe assembly 220 can be spaced apart along a transverse column direction C, such that the electrical contacts 250 of adjacent leadframe assemblies 220 are arranged in spaced apart, substantially parallel transverse columns. The second electrical connector 210 may include an organizer 230 that retains the leadframe assemblies 220 in their desired orientation in the connector housing 240, for instance via slits 280 that are defined in the organizer 230. The organizer 230 can be electrically insulative or electrically conductive as desired.

The electrical contacts 250 can include a plurality of signal contacts S and a plurality of ground contacts G. The second electrical connector 210 can include two different types of leadframe assemblies 220a and 220b that can be alternately arranged along the row direction R. The first type 220a of leadframe assembly 220 can define an arrangement of the electrical contacts 250 in a repeating G-S-S pattern along the mating interface 260 between the top and the bottom ends 222a and 222b of the leadframe housing 222, wherein “G” represents a ground contact and “S” represents a signal contact. The second type 220b of leadframe assembly 220 can define an arrangement of the electrical contacts 250 in a repeating S-S-G pattern along the mating interface 260 between the top and the bottom ends 222a and 222b of the leadframe housing 222. Thus, the first and second types 220a and 220b of leadframe assemblies 220 can define different patterns of signal and ground contacts. Alternatively, the types 220a and 220b of leadframe assemblies 220 can define the same pattern of signal and ground contacts. Adjacent pairs of signal contacts S of each leadframe assembly 220 can define differential signal pairs, or the signal contacts S can alternatively be single ended. It should be further appreciated that the mating interface 260 can define an open pin field, such that the ground contacts G can alternatively be provided as signal contacts that can have a data transfer speed that is different (for instance less) than that of the other signal contacts S.

In accordance with the illustrated embodiment, the mating interface 260 of the second electrical connector 210 is oriented substantially perpendicular with respect to the mounting interface 270, and the mating ends 280 of the electrical contacts 250 are oriented substantially perpendicular with respect to the mounting ends 290. Thus, the second electrical connector 210 can be referred to as a right-angle electrical connector, and the electrical contacts 250 can be referred to as right-angle electrical contacts. It should be appreciated that the second electrical connector 210 can alternatively be configured as a vertical electrical connector similar to the first electrical connector 110 described above, whereby the mating interface 260 extends substantially parallel to the mounting interface 270, and that the electrical contacts 250 can be configured as vertical contacts whose mating ends 280 are oriented substantially parallel with respect to the mounting ends 290. Furthermore, the mating ends 280 of the electrical contacts 250 are configured as receptacles that are configured to receive the mating ends 150 of the complementary electrical contacts 130 of the first electrical connector 110. Thus, the second electrical connector 210 can be referred to as a receptacle connector. Alternatively, the electrical contacts 250 can be configured as header contacts whose mating ends 280 are configured to be plugged into, or received by, complementary receptacle contacts.

In accordance with the illustrated embodiment (see FIG. 1), the first and second electrical connectors 110 and 210 can be configured to be mated such that the respective first and second substrates 112 and 212 extend orthogonal to each other. Alternatively, the first and second substrates 112 and 212 can extend parallel to each other when the electrical connectors 110 and 210 are mated. Accordingly, it should be appreciated that the substrates 112 and 212 can be arranged in an orthogonal or a co-planar configuration.

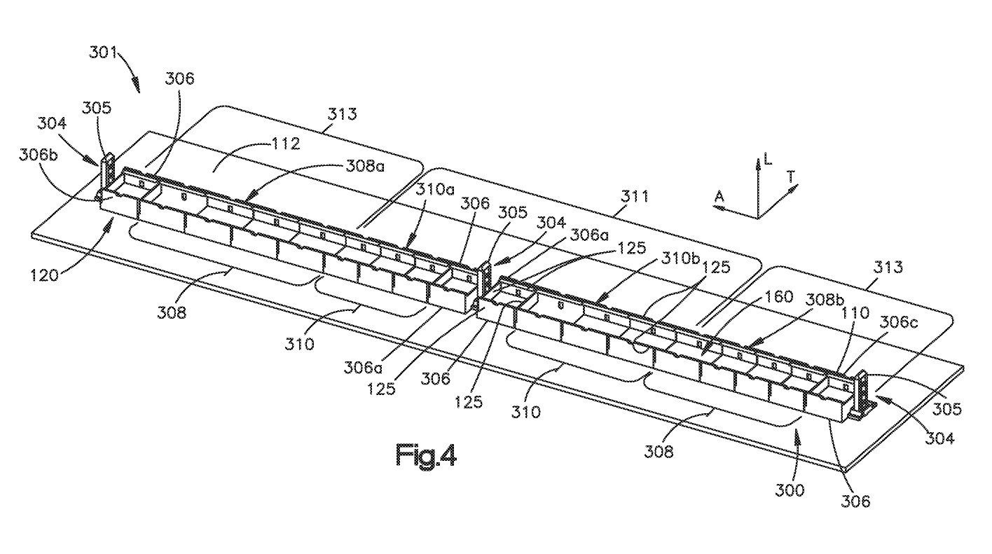

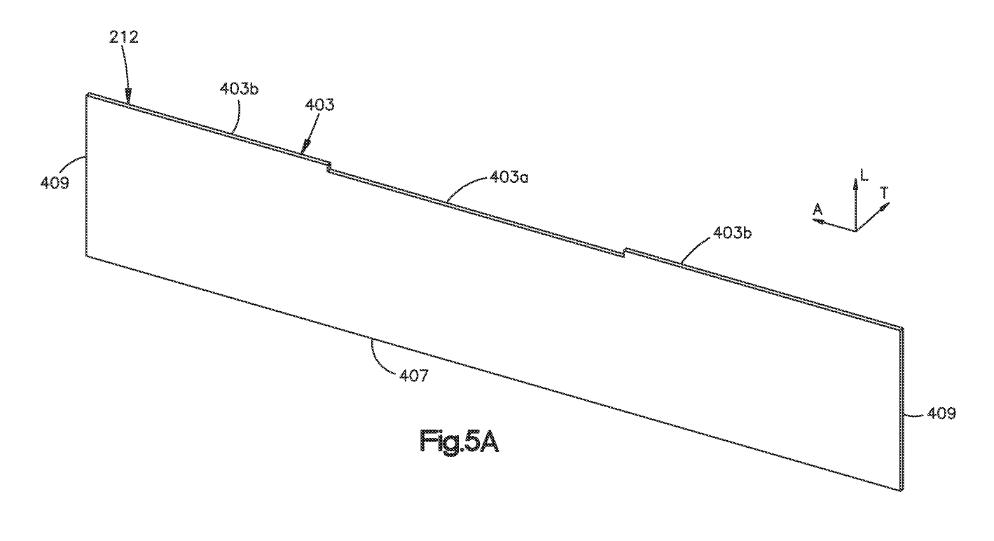

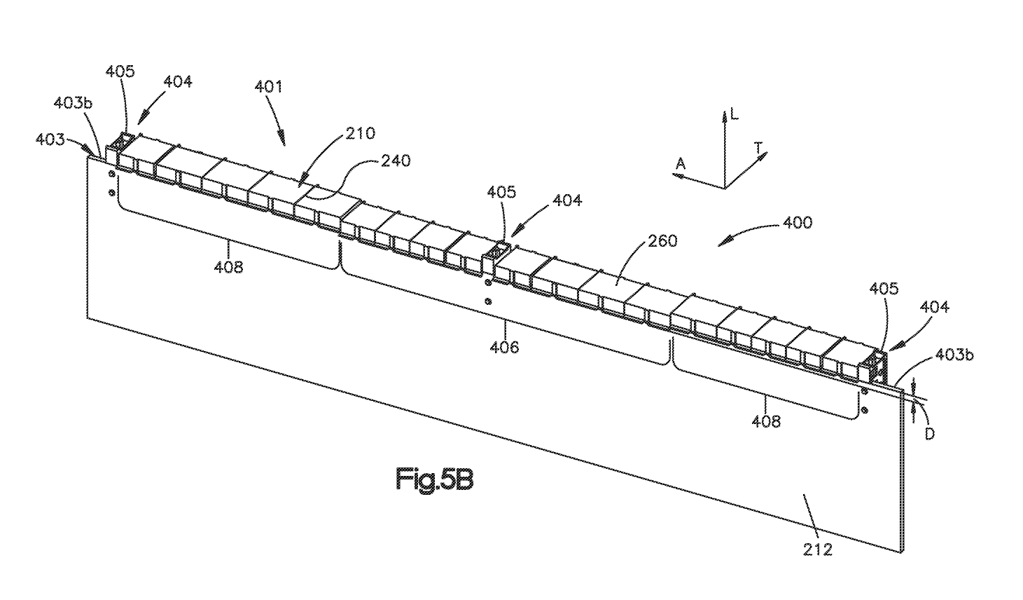

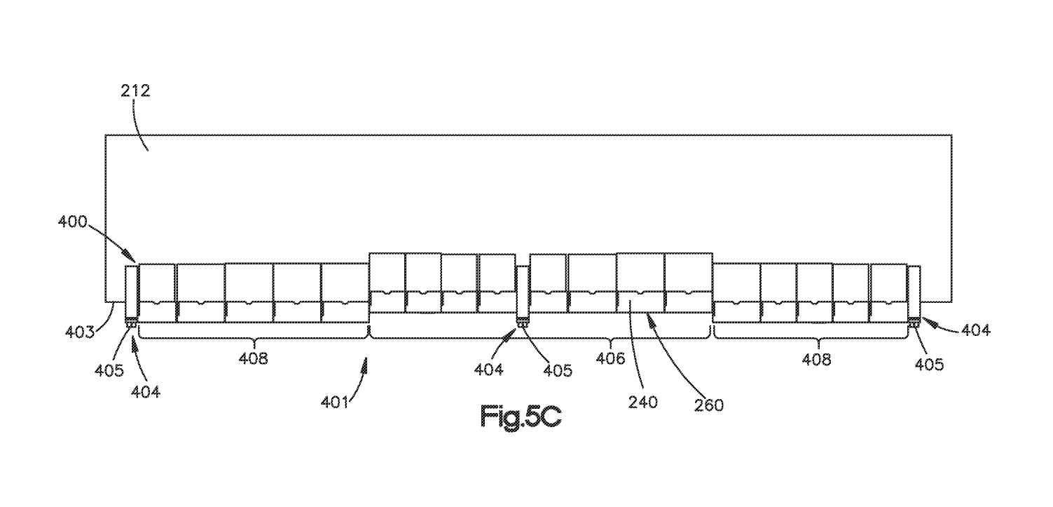

Referring now to FIG. 4, a first electrical component 301 includes the first array 300 of the first plurality of electrical connectors 110 configured to be mounted onto the first substrate 112 in the manner described above. In particular, the mounting ends 140 of the electrical connectors 110 are press-fit into plated through-holes formed in the first substrate 112, so as to be placed in electrical communication with the electrical traces running through or along the first substrate 112. As illustrated, the electrical connector assembly 100 can include at least one guide member 304, such as a plurality of guide members 304 associated with the first plurality of electrical connectors 110. The guide members 304 can be configured as desired, and are illustrated as posts 305, that extend longitudinally outward from the substrate 112 along a direction substantially parallel to the insertion direction. The posts 305 are illustrated as disposed on opposed lateral sides of the first plurality of electrical connectors 110 of the first array 300, and disposed between adjacent electrical connectors 110. The posts 305 can extend from the surface of the substrate 112, or can extend from a respective one or more of the electrical connectors 110, to a location longitudinally forward with respect to the mating interfaces 160 of the first electrical connectors 110. The guide members 304 are configured to engage complementary guide members 404 (see FIGS. 5B-C) associated with the second plurality of electrical connectors 210 so as to provide rough alignment between the electrical connectors 110 and 220 as the electrical connectors 110 and 220 are mated to each other. It should be appreciated that the alignment members 304 are configured as posts 305 in accordance with one embodiment, and that the alignment members 304 can alternatively be configured as desired to mate with a complementary alignment member so as to facilitate alignment of the electrical connectors 110 with complimentary electrical connectors.

In accordance with the illustrated embodiment, the first array 300 defines a linear array in the lateral direction A, though it should be appreciated that the first plurality of electrical connectors 110 can alternatively be arranged in any geometrical configuration as desired so as to mate with complementary electrical connectors of the second substrate. For example, regions of the first array of electrical connectors can be offset from each other, for example along the transverse direction T.

As illustrated, the connector housings 120 of a select at least one such as a plurality 306 of the electrical connectors 110 of the first array 300 can include four side walls 125, including pair of transversely opposed walls and a pair of laterally opposed walls, that substantially surround the electrical contacts 130 retained in the respective connector housings 120. The select plurality 306 of electrical connectors 110 can be disposed adjacent the alignment members 304, and the side walls 125 protect the electrical contacts 130 as the complimentary electrical connectors 110 and 210 are mated. For instance, as the second electrical connectors 210 are mated to the select plurality 306 of electrical connectors 110, the side walls 125 of the connector housings 120 engage the connector housings 240 of the complementary electrical connectors 210, so as to more precisely align the connectors 110 and 210 and their corresponding electrical contacts 138 and 250 as the connectors are mated, and to protect the mating ends 150 of the electrical contacts 130 from bending. It should be appreciated that the connector housings 120 of at least one, such as a plurality, up to all, of the electrical connectors 110 can be constructed as described with respect to the select plurality 306 of electrical connectors 110.

In accordance with the illustrated embodiment, each of the first electrical connectors 110 of the select first plurality 306 of electrical connectors 110 are configured to mate with complimentary electrical connectors of the second plurality of electrical connectors 210 that retain a first number of leadframe assemblies 220 (for instance twelve) of the type described above. Thus, the electrical contacts 130 of the first plurality 306 of electrical connectors 110 can be arranged in a corresponding first number of columns (for instance twelve). The first array 300 of electrical connectors 110 further defines a second plurality 308 of electrical connectors 110 whose connector housings 120 are configured differently than the connector housings 120 of the first plurality 306 of the electrical connectors 110. For instance, the connector housings 120 of the second plurality 308 of electrical connectors 110 can define only a pair of walls 125, such as transversely opposed walls, spaced walls that are configured to mate with the respective connector housings 140 of the complementary second electrical connectors 210. Furthermore, the electrical contacts 130 of the second plurality 308 of electrical connectors 110 can be arranged in a different number of second columns than the electrical contacts 130 of the first plurality 306 of electrical connectors 110. Thus, the electrical contacts 130 of the second plurality 308 of electrical connectors 110 can define a number of second columns that is greater than the first number of columns defined by the electrical contacts 130 of the first plurality 306 of electrical connectors 110, though it should be appreciated that the electrical contacts 130 of the second plurality 308 of electrical connectors 110 can alternatively define a number of columns that is equal to or less than the number of columns defined by the electrical contacts 130 of the first plurality 306 of electrical connectors 110. In accordance with the illustrated embodiment, the electrical contacts 130 of the second plurality 308 of electrical connectors 110 define sixteen columns.

The first array 300 of electrical connectors 110 can further define a third plurality 310 of vertical header electrical connectors 110 whose connector housings 120 can define pair of transversely opposed walls 125 as described above with respect to the connector housings 120 of the second plurality 308 of electrical connectors 110. Furthermore, the electrical contacts 130 of the third plurality 310 of electrical connectors 110 can be arranged in a different number of third columns than the electrical contacts 130 of the second plurality 308 of electrical connectors 110. For instance, the electrical contacts 130 of the third plurality 310 of electrical connectors 110 can define a number of columns that is less than the number of columns defined by the electrical contacts 130 of the second plurality 308 of electrical connectors 110. In particular, the electrical contacts 130 of the third plurality 310 of electrical connectors 110 can define a number of columns that is equal to the number of columns (e.g., twelve columns) defined by the electrical contacts 130 of the first plurality 306 of electrical connectors 110. Alternatively, it should be appreciated that the electrical contacts 130 of the third plurality 310 of electrical connectors 110 can define a number of columns that is equal to or different (e.g., less than or greater than) the number of columns defined by the electrical contacts 130 of the first and second pluralities 306 and 308 of electrical connectors 110.

Because the column of the first, second, and third pluralities 306, 308, and 310 of electrical connectors 110, respectively, can define an equal number of electrical contacts 130, those electrical connectors 110 having more columns than another electrical connector 110 can likewise include a greater number of electrical contacts 130 than the other electrical connector. Likewise, those electrical connectors 110 having an equal number of columns with respect to another electrical connector 110 can likewise include an equal number of electrical contacts 130. Thus, the electrical connectors 110 of the third plurality 310 of electrical connectors 110 can have a different number (e.g., fewer) electrical contacts 130 with respect to the second plurality 308 of electrical connectors 110, and can have an equal number of electrical contacts 130 with respect to the inner 306a and outer 306b-c electrical connectors of the first plurality of electrical connectors 306. Alternatively, it should be appreciated that the electrical connectors 110 of the third plurality 310 of electrical connectors 110 can have an equal number or a different number (e.g., a greater number, or fewer) of electrical contacts 130 with respect to the first and second pluralities 306 and 308 of electrical connectors 110, respectively. It should be further appreciated that the electrical connectors 100 of the second plurality 308 of electrical connectors 110 can include an equal number of columns (e.g., sixteen) and corresponding electrical contacts 130 as the outer electrical connectors 306b-c of the first plurality of electrical connectors 110.

In accordance with the illustrated embodiment, the third plurality 310 of electrical connectors 110 is disposed laterally inward with respect to the second plurality of electrical connectors 110. Furthermore, the third plurality 310 of electrical connectors 110 can be separated into two equal groups of electrical connectors 110 separated by one of the first plurality 306 of electrical connectors 110. Thus a first group 310a of the third plurality 310 of electrical connectors 110 can be disposed between a select one or more, such as select inner ones 306a, of the first plurality 306 of electrical connectors 110 and a first group 308a of the second plurality 308 of electrical connectors 110. A second group 310b of the third plurality 310 of electrical connectors 110 can be disposed between the select one of the first plurality of electrical connectors 110 and a second group 308b of the second plurality 308 of electrical connectors 110. The first group 308a of the second plurality 308 of electrical connectors 110 can be disposed between the first group 310a of the third plurality 310 of electrical connectors 110 and a first select one, such as a first outer one 306b, of the first plurality 306 of electrical connectors 110, and the second group 308b of the second plurality 308 of electrical connectors 110 can be disposed between the second group 310b of the third plurality 310 of electrical connectors 110 and a second select one, such as a second outer one 306c, of the first plurality 306 of electrical connectors 110. The electrical connectors 110 of the third plurality 310 can be aligned with at least one, such as a plurality, up to all, of the electrical connectors 110 one or both of the first of the first and second 306 and 308 pluralities of electrical connectors 110 with respect to the lateral direction.

Referring now to FIGS. 5A-C, a second electrical component 401 includes the second array 400 of electrical connectors 210 configured to be mounted onto the second substrate 212 in the manner described above. In particular, the mounting ends 290 of the electrical connectors 210 are press-fit into plated through-holes formed in the second substrate 212, so as to be placed in electrical communication with the electrical traces running through or along the second substrate 212. Accordingly, when the electrical connectors 110 and 210 are mated, the first and second substrates 112 and 212 can be placed in electrical communication with each other. As illustrated, the electrical connector assembly 100 can include at least one guide member 404, such as a plurality of guide members 404 associated with the second plurality of electrical connectors 210. The guide members 404 can be configured as desired, and are illustrated as silos 405, that extend longitudinally outward from the substrate 212 along a direction substantially parallel to the longitudinal insertion direction. The silos are illustrated as disposed on opposed lateral sides of the second plurality of electrical connectors 210 of the second array 400, and disposed between adjacent electrical connectors 210. The silos 405 can extend from the surface of the substrate 212, or can extend from a respective one or more of the electrical connectors 210, to a location longitudinally forward with respect to the mating interfaces 260 of the second electrical connectors 210. The guide members 404 are configured to engage the complementary guide members 304 associated with the first plurality of electrical connectors 110 (see FIG. 4) so as to provide rough alignment between the electrical connectors 110 and 220 as the electrical connectors 110 and 220 are mated to each other. It should be appreciated that the alignment members 404 are configured as silos 405 in accordance with one embodiment, and that the alignment members 404 can alternatively be configured as desired to mate with a complementary alignment member so as to facilitate alignment of the electrical connectors 210 with complimentary electrical connectors.

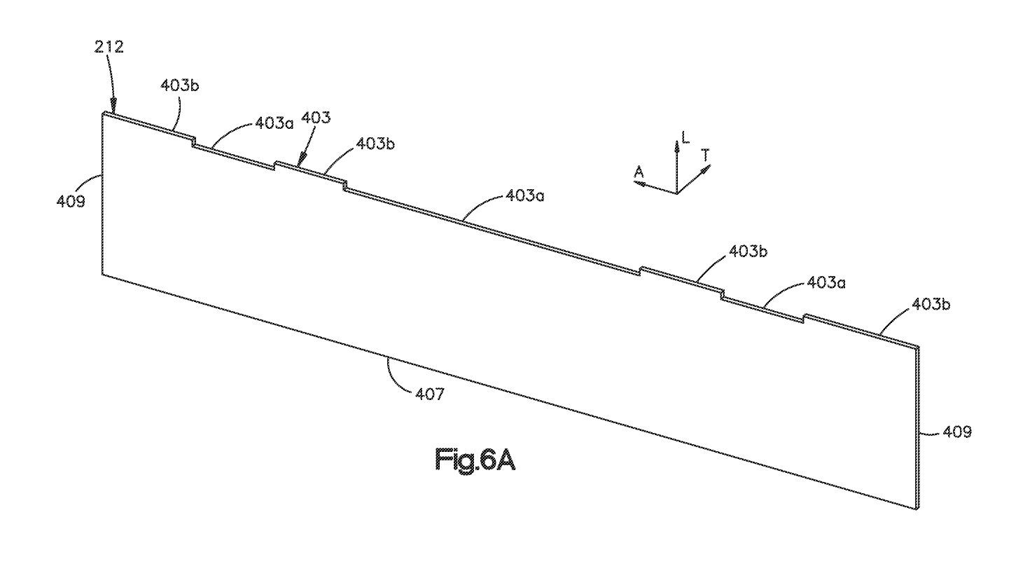

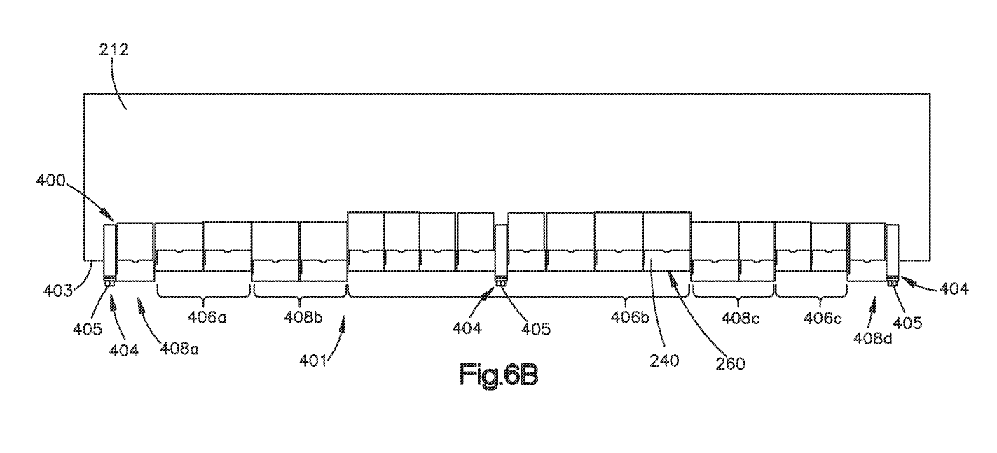

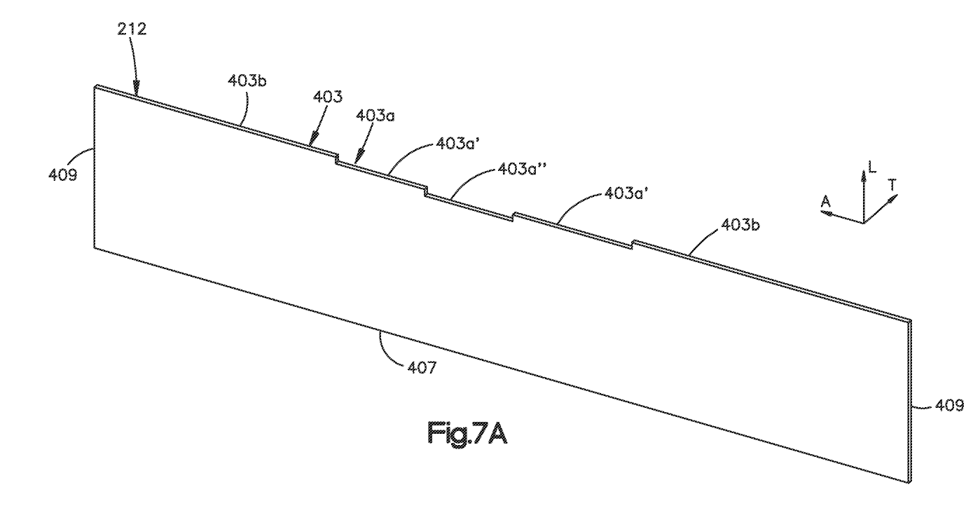

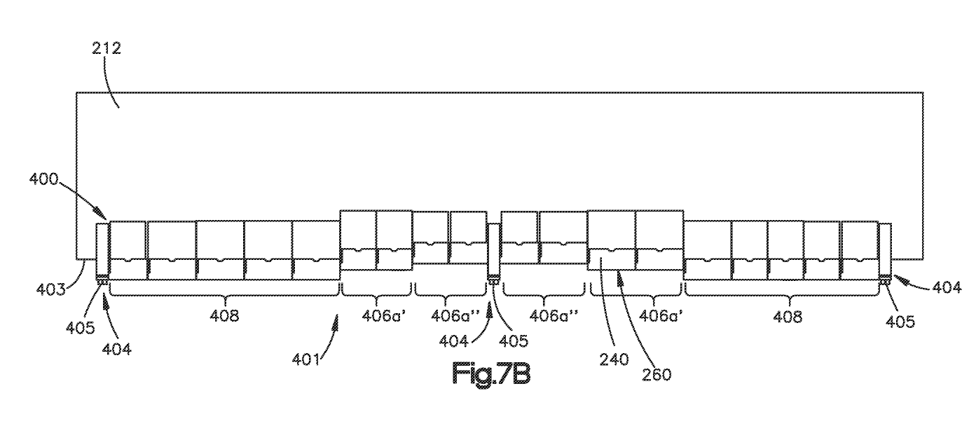

The second substrate 212 defines a longitudinally front edge 403, an opposed longitudinally rear edge 407, and a pair of laterally opposed side edges 409. The front edge 403 defines at least one recessed first region 403a that is offset longitudinally inward, or longitudinally recessed, with respect to adjacent, or second remainder regions 403b of the front edge 403. Thus, the second regions 403b are longitudinally outwardly displaced with respect to the recessed first regions 403a of the front edge 403. In accordance with the illustrated embodiment, the recessed first region 403a is a laterally inner region, and the second regions 403b are laterally outer regions extending laterally outward from laterally opposed ends of the recessed region 403a. It should be appreciated that the front edge 403 can include any number of distinct recessed regions 403a as desired that can be located anywhere along the front edge 403 of the second substrate 212 as desired (see FIGS. 6A-B). Furthermore, at least one up to all of the recessed regions 403a can define a substantially constant offset, or can define a variable (e.g., stepped) offset (see FIGS. 7A-B).

The electrical connectors 210 of the second array 400 can be mounted onto the front edge 403 of the second substrate 212, and can include at least one such as a first plurality 406 of electrical connectors 210 mounted onto the first region 403a of the front edge 403, and at least one such as a second plurality 408 of electrical connectors 210 mounted onto the second region 403b of the front edge 403. The electrical connectors 210 can be mounted onto the substrate 212 at a consistent location relative to the edge 403. As a result, the electrical connectors 210 of the first plurality 406 of electrical connectors 210 are longitudinally recessed with respect to the electrical connectors 210 of the second plurality 408 of electrical connectors 210 along the insertion direction. For instance, the mating interfaces 260 of the electrical connectors 210 of the first plurality 406 of electrical connectors 210 is longitudinally recessed with respect to the mating interfaces 260 of the electrical connectors 210 of the second plurality of electrical connectors 210 along the insertion direction. Additionally, the mating ends 280 of at least one up to all of the electrical contacts 250 of the first plurality 406 of electrical connectors 210 is longitudinally recessed with respect to the at least one up to all of the mating ends 280 of electrical contacts 250 of the electrical connectors 210 of the second plurality of electrical connectors 210 along the insertion direction.

The recessed region 403a of the edge 403 can be offset with respect to the adjacent remainder regions 403b through an offset distance D greater than approximately 0.25 mm, such as greater than approximately 0.5 mm, and less than the wiping distance of the electrical contacts 250 of the second electrical connector 210 when mated with the electrical contacts 130 of the first electrical connector 110. In accordance with one embodiment, the offset distance D can be between approximately 0.25 mm and approximately 1.0 mm, such as between approximately 0.5 mm and approximately 0.75 mm. Furthermore, the offset distance D can be equal to the recess of the first region 403a of the front edge 403 of the second substrate 212 with respect to the second region 403b.

Alternatively, the edge 403 of the second substrate 212 can be smooth and straight, and thus not include a recessed region 403a, and that the first plurality 406 of electrical connectors 210 can be set back, or offset, from the edge 403 of the substrate 212 with respect to the second plurality 408 of electrical connectors a suitable distance as described above with respect to the offset of the recessed region 403a, for example by offsetting mounting locations, such as plated through holes, of the substrate 212 that are connected to the mounting ends 290 of the electrical contacts 250 of the electrical connectors 210 of the first plurality 406 of electrical connectors 210 longitudinally rearward with respect to the mounting ends that are configured to electrically connect to the mounting ends 290 of the electrical contacts 250 of the electrical connectors 210 of the second plurality 408 of electrical connectors 210. It should be further appreciated that the mating ends 280 of the electrical contacts 250 of the second plurality 408 of electrical connectors 210 can be longer along the longitudinal insertion direction than the mating ends 280 of the electrical contacts 250 of the first plurality 406 of electrical connectors 210. Accordingly, the mounting ends 290 of the electrical contacts 250 of the first and second pluralities 406 and 408 of electrical connectors 210 can be mounted onto laterally aligned locations on the second substrate 212, such that the mating ends 280 of the electrical contacts 250 of the first plurality 406 of electrical connectors 210 is longitudinally recessed with respect to the mating ends 280 of the electrical contacts of the second plurality 408 of electrical connectors 210. Alternatively, the second array 400 or electrical connectors can be constructed of electrical connectors 210, all of which are substantially the same size (e.g., length in the insertion direction), that are mounted such that the second array 400 is linearly aligned with respect to the edge 403 of the substrate 212, with some up to all of the electrical connectors 210 having mating ends 280 of various lengths.

In accordance with the illustrated embodiment, the first plurality 406 of electrical connectors 210 includes a first number of columns of electrical contacts 250 (e.g., leadframe assemblies 220 of the type described above), and the second plurality 408 of electrical connectors 210 a second number of columns of electrical contacts 250 (e.g., leadframe assemblies 220 of the type described above). In accordance with the illustrated embodiment, the first number of columns is less than the second number of columns, though the first number of columns can alternatively be greater than or equal to the second number of columns. For instance, the first number of columns can be twelve, and the second number of columns can be sixteen. Thus, the first plurality 406 of electrical connectors 210 can define a number of columns of electrical contacts 250 that is equal to the number of columns of the third plurality 310 of electrical connectors 110 and the select inner ones 306a of the first plurality 306 of electrical connectors 110 that are configured to mate with the first plurality 406 of electrical connectors 210.

Furthermore, the second plurality 408 of electrical connectors 210 can define a number of columns of electrical contacts 250 that is equal to the number of columns of the second plurality 308 of electrical connectors 110 and the outer ones 306b and 306c of the first plurality 306 of electrical connectors 110 that are configured to mate with the second plurality 408 of electrical connectors 210. Otherwise stated, the third plurality 310 and the select inner ones 306a of the electrical connectors 110 define a first plurality 311 of electrical connectors 110 of the first array 300 of electrical connectors 110 that are configured to mate with the first plurality 406 of the second array 400 of electrical connectors 220. Furthermore, the second plurality 308 and the select outer ones 306b and 306c of the electrical connectors 110 define a second plurality 313 of electrical connectors 110 of the first array 300 of electrical connectors 110 that are configured to mate with the second plurality 408 of the second array 400 of electrical connectors 220.

The electrical connectors 210 of the first plurality 406 of electrical connectors 210 can have an equal number of columns and corresponding electrical contacts 250 as the electrical connectors 110 of the corresponding first plurality 311 of electrical connectors 110. Likewise, the electrical connectors 210 of the second plurality 408 of electrical connectors 210 can have an equal number of columns and corresponding electrical contacts 250 as the electrical connectors 110 of the corresponding second plurality 313 of electrical connectors 110.

It is recognized that the insertion force required to mate complementary electrical connectors 110 and 210 increases with increasing numbers of the associated electrical contacts 130 and 250, respectively, that are mated. Because the mating ends 280 of the first plurality 406 of electrical connectors 210 of the second array 400 are recessed with respect to the mating ends 280 of the second plurality 408 of electrical connectors 210, when the first and second arrays 300 and 400 of electrical connectors are mated, the mating ends 280 of the second plurality 408 of electrical connectors 210 of the second array 400 engage the complimentary mating ends 150 of the first plurality 311 of electrical connectors 110 of the first array 300 before the mating ends 280 of the first plurality 406 of electrical connectors 210 engage the mating ends 150 of the second plurality 313 of electrical connectors 110. Accordingly, because the number of mating ends 280 of the electrical contacts 250 of the electrical connectors 210 in the second array 400 that initially engage the mating ends 150 of the electrical contacts 130 of the electrical connectors 110 in the first array 300 is reduced with respect to an otherwise configured second array 400 of electrical connectors 210 that does not include any recessed electrical connectors, the peak insertion force (or greatest insertion force required when mating the arrays 300 and 400 of electrical connectors 110 and 210, respectively) is correspondingly reduced when mating the electrical connectors 110 and 210 of the first and second arrays 300 and 400.

It should be appreciated that while the electrical connectors 110 of the first array 300 of electrical connectors 110 are all depicted as having a constant transverse height with respect to the first substrate 112, that one or more of the electrical connectors 110 can be have a height that is offset or reduced with respect to one or more other of the electrical connectors 110. For example, one or more electrical connectors 110 can be mounted on a raised portion (not shown) of the first substrate 112, the raised portion extending transversely upward, or one or more electrical connectors 110 can be configured with longer mounting ends 150 than the one or more other electrical connectors 110.

It should further be appreciated that the electrical connectors 110 and 210 of the first and second arrays 300 and 400 are illustrated as being mounted immediately adjacent to one another on the respective first and second substrates 112 and 212, with little or no space in between the respective connector housings of the electrical connectors.

Referring now to FIG. 6A, the at least one first recessed region 403a of the front edge 403 can define a plurality of recessed regions 403a, and the at least one remainder region 403b of the front edge 403 can define a plurality of second remainder regions 403b disposed adjacent to the recessed regions 403a. For instance, at least one of the remainder regions 403b can extend between a pair of recessed regions 403a. As described above, the recessed regions 403a are offset longitudinally inward, or longitudinally recessed, with respect to the adjacent remainder regions 403b of the front edge 403. Thus, the second remainder regions 403b are longitudinally outwardly displaced with respect to the recessed first regions 403a of the front edge 403. In accordance with the illustrated embodiment, the recessed first region 403a is a laterally inner region, and the second regions 403b are laterally outer regions extending laterally outward from laterally opposed ends of the recessed region 403a. It should be appreciated that the front edge 403 can include any number of distinct recessed regions 403a as desired that can be located anywhere along the front edge 403 of the second substrate 212 as desired. One or more up to all of the recessed regions 403a can define a substantially constant longitudinal offset distances with respect to one or more up to all of the remainder regions 403b. Alternatively, one or more up to all of the recessed regions 403a can define a different longitudinal offset distances with respect to one or more up to all of the remainder regions 403b.

Accordingly, referring also to FIG. 6B, the second electrical component 401 can include the second array 400 of electrical connectors 210 configured to be mounted onto the second substrate 212 such that the first plurality 406 of electrical connectors 210 includes at least one group, such as a plurality of groups 406a-c, of at least one electrical connector 210 (including a plurality of electrical connectors 210) mounted onto the front edge 403 of the second substrate 212 at a corresponding one of the first recessed regions 403a. Furthermore, the second plurality 408 of electrical connectors 210 includes at least one group, such as a plurality of groups 408a-d, of at least one electrical connector 210 (including a plurality of electrical connectors 210) mounted onto the front edge 403 of the second substrate 212 at a corresponding one of the second regions 403b. Thus, the second array 400 of electrical connectors 210 can define a plurality of groups of a first at least one electrical connector 210 such as a plurality of electrical connectors 210 that are offset with respect to a plurality of groups of a second at least one electrical connector 210 such as a plurality of electrical connectors 210. One or more of the groups 406a-c can define a substantially constant longitudinal offset distances with respect to one or more up to all of groups 408a-d. It should be appreciated that the mating interfaces 260, and mating ends 280, of the offset electrical connectors of the groups 406a-c of electrical connectors 210 are longitudinally recessed with respect to the mating interfaces 260, and mating ends 280, of the electrical connectors 210 of the electrical connectors of the groups 408a-d of electrical connectors 210 along the insertion direction. Furthermore, one or more up to all of the groups 406a-c can define a different longitudinal offset distances with respect to both each other and one or more up to all of the groups 408a-d.

Referring now to FIG. 7A, the front edge 403 can define a first recessed region 403a′ and a second recessed region 403a″ that are each offset longitudinally inward, or longitudinally recessed, with respect to the adjacent remainder regions 403b at different offset distances. Thus, the second recessed region 403a″ can define an offset that is greater than the offset of the first recessed region 403a′. Further, the second recessed region 403a″ can be nested in the first recessed region 403a′ as illustrated. Alternatively, the second recessed region 403a″ can be spaced from the first recessed region 403a′ as described above with respect to the recessed regions 403a with reference to FIG. 6A. It should be appreciated that the front edge 403 can include any number of recessed regions 403a as desired that can be located anywhere along the front edge 403 of the second substrate 212, and can define any offset distance, greater than, equal to, or less than, the offset distance of at least one up to all of the other recessed regions 403a as desired.

Accordingly, referring also to FIG. 7B, the second electrical component 401 can include the second array 400 of electrical connectors 210 configured to be mounted onto the second substrate 212 such that the first plurality 406 of electrical connectors 210 includes at least one group, such as a first group 406a′ of at least one electrical connector 210 (including a plurality of electrical connectors 210) mounted onto the first recessed region 403a′ of the front edge 403, and a second group 406a″ of at least one electrical connector 210 (including a plurality of electrical connectors 210) mounted onto the second recessed region 403a″ of the front edge 403. Thus, the second group 406a″ of electrical connectors 210 can be recessed from the first group 406a′ of electrical connectors 210 with respect to the insertion direction. The first group 406a′ of electrical connectors can in turn be recessed from the electrical connectors 210 of the second plurality 408 of electrical connectors 210 with respect to the insertion direction. It should be appreciated that the mating interfaces 260, and mating ends 280, of the offset electrical connectors of the second group 406a″ of electrical connectors 210 are longitudinally recessed with respect to the mating interfaces 260, and mating ends 280, of the offset electrical connectors of the first group 406a′ of electrical connectors 210. The mating interfaces, and mating ends 280, of the offset electrical connectors 210 of the first group 406a′ of electrical connectors 210 in turn are longitudinally recessed with respect to the mating interfaces 260, and mating ends 280, of the offset electrical connectors of the second plurality 408 of electrical connectors 210.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated, for example the first and second arrays 300 and 400 of electrical connectors can be constructed using any combination of vertical and/or right angle connectors, header and/or receptacle connectors, and configured in any array geometry. Accordingly, those skilled in the art will realize that the invention is intended to encompass all modifications and alternative arrangements included within the spirit and scope of the invention, for instance as set forth by the appended claims.

What is claimed:

1. An array of electrical connectors comprising:
a first plurality of electrical connectors, each electrical connector of the first plurality of electrical connectors including a connector housing and a plurality of electrical contacts supported by the connector housing, each electrical contact defining a mounting end configured to electrically connect to a substrate and a mating end configured to electrically connect to a respective electrical contact of a complementary electrical connector of a second array of electrical connectors along an insertion direction; and
a second plurality of electrical connectors, each electrical connector of the second plurality of electrical connectors including a connector housing and a plurality of electrical contacts supported by the connector housing, each electrical contact of the second plurality of electrical contacts defining a mounting end configured to electrically connect to the substrate and a mating end configured to electrically connect to a respective electrical contact of a complementary electrical connector of the second array of electrical connectors along the insertion direction;
wherein the mating ends of the electrical contacts of the first plurality of electrical connectors are offset with respect to the mating ends of the electrical contacts of the second plurality of electrical connectors along the insertion direction, and at least one of the electrical connectors of the first plurality of electrical connectors has a different number of electrical contacts with respect to at least one of the electrical connectors of the second plurality of electrical connectors.

2. The array of electrical connectors as recited in claim 1, wherein the first and second pluralities of electrical connectors are configured to be mounted on an edge of the substrate.

3. The array of electrical connectors as recited in claim 2, wherein the first plurality of electrical connectors is configured to be mounted along a first region of the edge of the substrate that is recessed in the insertion direction with respect to a second region of the edge of the substrate along which the second plurality of electrical connectors is configured to be mounted.

4. The array of electrical connectors as recited in claim 1, wherein when the mating ends of the second plurality of electrical connectors engage the complementary electrical connector of the second array of electrical connectors before the mating ends of the first plurality of electrical connectors engage the complementary electrical connector of the second array of electrical connectors.

5. The array of electrical connectors as recited in claim 1, wherein the first and second pluralities of electrical connectors each comprise a plurality of leadframe assemblies arranged in columns.

6. The array of electrical connectors as recited in claim 1, wherein the at least one of the electrical connectors of the first plurality of electrical connectors has fewer electrical contacts with respect to the least one of the electrical connectors of the second plurality of electrical connectors.

7. The array of electrical connectors as recited in claim 1, wherein the first plurality of electrical connectors comprises a first group of at least one electrical connector, and a second group of at least one electrical connector, wherein the at least one electrical connector of the second group is further recessed from the second plurality of electrical connectors than the at least one electrical connector of the first group.

8. The array of electrical connectors as recited in claim 1, wherein the first plurality of electrical connectors comprises a plurality of groups of at least one electrical connector, and the second plurality of electrical connectors comprises a plurality of groups of at least one electrical connector, wherein at least one of the groups of the second plurality of electrical connectors is disposed adjacent at least one of the groups of the first plurality of electrical connectors.

9. An electrical connector assembly comprising:
a first electrical component comprising a first array of electrical connectors, the first array of electrical connectors including a first plurality of electrical connectors and a second plurality of electrical connectors, wherein the first plurality of electrical connectors are recessed with respect to the second plurality of electrical connectors; and
a second electrical component comprising a second array of electrical connectors, the second array of electrical connectors configured to mate with the first array of electrical components along the insertion direction;
wherein when the first and second electrical components are mated, the second plurality of electrical connectors mate with the second array of electrical connectors before the first plurality of electrical connectors mate with the second array of electrical connectors, and the first plurality of electrical connectors comprises a different number of electrical contacts than the second plurality of electrical connectors.

10. The electrical connector assembly as recited in claim 9, wherein the first and second arrays of electrical connectors comprise leadframe assemblies.

11. The electrical connector assembly as recited in claim 9, wherein the first and second pluralities of electrical connectors are configured to be mounted on an edge of the substrate.

12. The electrical connector assembly as recited in claim 9, wherein when the mating ends of the second plurality of electrical connectors engage complementary electrical connectors of the second array before the mating ends of the first plurality of electrical connectors engage complementary electrical connectors of the second array.

13. The array of electrical connectors as recited in claim 9, wherein at least one of the first plurality of electrical connectors has fewer electrical contacts with respect to the least one of the second plurality of electrical connectors.

14. A method of reducing an insertion force required to mate electrical components, the method comprising:
mounting a first plurality of electrical connectors of a first array to a substrate, each of the first plurality of electrical connectors defining a first number of electrical contacts; and
mounting a second plurality of electrical connectors of the first array to the substrate adjacent to the first plurality of electrical connectors and offset from the first plurality of electrical connectors along an insertion direction, each of the second plurality of electrical connectors defining a second number of electrical contacts that is different than the first number of electrical contacts; and
mating the first array of electrical connectors with a second array of complimentary electrical connectors along the insertion direction, such that the second plurality of electrical connectors mate with the complimentary electrical connectors before the first plurality of electrical connectors engage the complimentary electrical connectors.

15. The method as recited in claim 14, wherein the first mounting step comprises mounting the first plurality of electrical connectors onto a recessed region of the substrate.
